(19) United States
(12) Patent Application Publication
(10) Pub. No.: US 2013/0154808 A1
(43) Pub. Date: Jun. 20, 2013

(54) ELECTRICAL OUTLET FOR AUTOMATICALLY SENSING ELECTRICAL DEVICE, SYSTEM FOR MANAGING ENERGY USING THE ELECTRICAL OUTLET, AND METHOD THEREOF

(71) Applicants: Jin Soo HAN, Daejeon (KR); Chang Sic CHOI, Daejeon (KR); Wan Ki PARK, Daejeon (KR); Il Woo Lee, Daejeon (KR)

(72) Inventors: Jin Soo HAN, Daejeon (KR); Chang Sic CHOI, Daejeon (KR); Wan Ki PARK, Daejeon (KR); Il Woo Lee, Daejeon (KR)

(73) Assignee: Electronics and Telecommunications Research Institute, Daejeon (KR)

(21) Appl. No.: 13/620,091

(22) Filed: Sep. 14, 2012

(30) Foreign Application Priority Data
Dec. 20, 2011 (KR) 10-2011-0138528

(51) Int. Cl. G06K 7/01; H02J 4/00

(52) U.S. Cl. 340/10.5; 307/31

(57) ABSTRACT

An electrical outlet for automatically sensing an electrical device, a system for managing electric energy using the electrical outlet, and a method thereof are disclosed. The electrical outlet may include a plug connecting unit to which a plug of an electrical device including a radio frequency identification (RFID) tag is connected, an RFID reader for receiving information about the electrical device from the RFID tag, an electric energy measuring unit for measuring an amount of electric energy consumed by the electrical device, a controller for managing the received information about the electrical device and information about the measured amount of electric energy, and a communication unit for transmitting the information about the electrical device and the information about the amount of electric energy used to an electric energy management system.

### CROSS-REFERENCE TO RELATED APPLICATION

This application claims the priority benefit of Korean Patent Application No. 10-2011-0138528, filed on Dec. 20, 2011, in the Korean Intellectual Property Office, the disclosure of which is incorporated herein by reference.

### BACKGROUND

1. Field of the Invention

The present invention relates to an electrical outlet for automatically sensing an electrical device connected thereto to automatically sense an electrical device for managing energy consumed by the electrical device, a system for managing electric energy using the electrical outlet, and a method thereof.

2. Description of the Related Art

A conventional electrical outlet immediately supplies power to drive an electrical device when the electrical device is connected thereto. In such a case, since it is not possible to determine a type of the electrical device and an amount of electric energy consumed by the electrical device, it is not possible to manage the amount of electric energy consumed by the electrical device.

An electric energy management system provides a network function to the electrical outlet and stores information for identifying an electrical device connected to an electrical outlet and registered by a user in the electric energy management system so that the electrical device is matched to the electrical outlet and management of the electric energy usage of the electrical device is enabled. Accordingly, it is possible to monitor and manage the electric energy usage of the electrical device through the user interface of the electric energy management system. The electric energy management system is useful for managing an amount of the electric energy supplied to the electrical device when the electrical device is connected to the electrical outlet. However, when the electrical device is frequently moved to different electrical outlets, inputting a change of location of the electrical device through the user interface may be necessary and difficult each time a location of the electrical device changes, and correspondingly frequent user input may be required.

In addition, an electrical outlet composed of a radio frequency identification (RFID) reader, a power switching apparatus, a current detector, and a controlling apparatus is designed to read data from the RFID tag of the device connected to the electrical outlet and to supply power only when the RFID tag is valid. When the RFID tag is absent or is invalid, or when a certain conductive substance is inserted, a power off state is maintained to prevent electricity waste or an accident. When a maximum current value recorded in the RFID tag is exceeded, power is blocked so that an accident due to an overload may be prevented. The connection of the electrical device is automatically recognized so that an accident may be prevented through a validity test and an overload test. However, since it is not possible to gauge the amount of electric energy usage of the corresponding electrical device and the electrical outlet is not connected to a network that may be interlocked with the electric energy management system, it is difficult to use the electrical outlet for the electric energy management system.

In another conventional technology, an electrical outlet includes an RFID reader and a communication module so that, when an electrical device to which an RFID tag is attached is connected to the electrical outlet including the RFID reader, information to be used for recognition of the connected electrical device is transmitted to a home server through the communication module. In this technology, the home server may identify a location of the electrical device on a home network so that information is transmitted to the electrical device at a predetermined location, which differs from a technology for managing an amount of electric energy used by the electrical outlet.

### SUMMARY

An aspect of the present invention provides electrical outlets for automatically sensing electrical devices, in which various electrical devices connected to electrical outlets are automatically identified and an amount of electric energy consumed by the electrical devices is measured even when the electrical devices are connected to different electrical outlets since histories of electric energy usage of the electrical devices are continuously managed, a system for managing electric energy using the electrical outlets, and a method thereof.

Another aspect of the present invention also provides an electrical outlet for automatically sensing an electrical device capable of minimizing an amount of electric energy consumed by an electric energy management system when the amount of electric energy used by the electrical device is managed, a system for managing electric energy using the electric outlet, and a method thereof.

According to an aspect of the present invention, there is provided an electrical outlet, including a plug connecting unit to which the plug of an electrical device including a radio frequency identification (RFID) tag is connected, an RFID reader for transmitting a radio frequency (RF) signal to receive information about the electrical device from the RFID tag, an electric energy measuring unit for measuring an amount of electric energy consumed by the electrical device, a controller for managing the received information about the electrical device and information about the amount of consumed electric energy, and a communication unit for transmitting the information about the electrical device and the information about the amount of consumed electric energy to an electric energy management system.

According to an aspect of the present invention, the RFID reader may cease transmission of the RF signal when the information about the electrical device is received from the RFID tag.

According to another aspect of the present invention, the RFID reader may transmit the RF signal when the amount of electric energy consumed by the electrical device is measured and may cease transmission of the RF signal when the information about the electrical device is received through the transmitted RF signal.

According to still another aspect of the present invention, the plug connecting unit may include a plug sensor for sensing whether the plug is connected.

According to still another aspect of the present invention, the RFID reader may transmit the RF signal when the plug is sensed to be connected, to receive the information about the electrical device from the RFID tag and may cease transmission of the RF signal when the information about the electrical device is received.

According to still another aspect of the present invention, the plug sensor may be provided on one side of a connection plane between the electrical outlet and the plug of the electrical device to sense whether the plug is connected.

According to another aspect of the present invention, there is provided a system for managing an amount of electric energy consumed by a plurality of electrical devices that may receive information from RFID tags corresponding to electrical devices included in the plurality of electrical devices and may receive information about the electrical devices and information about electric energy usage from a plurality of electrical outlets for measuring the amount of electric energy consumed by the electrical devices to manage the amount of electric energy consumed by the electrical devices.

According to still another aspect of the present invention, there is provided a method of managing an amount of electric energy consumed by a plurality of electrical devices, the method including transmitting information about the plurality of electrical devices from RFID tags to electrical outlets and measuring the amount of electric energy consumed by the plurality of electrical devices when the plugs of the plurality of electrical devices including the RFID tags are connected to the plurality of electrical outlets and transmitting the transmitted information about the plurality of electrical devices and information about the measured amount of electric energy consumed from the plurality of electrical outlets to an electric energy managing system.

When the plug of the electrical device to which the RFID tag is attached is connected to the electrical outlet, information about the corresponding electrical device is received from the RFID tag, the amount of electric energy consumed by the corresponding electrical device is measured, and the measurement result is transmitted to the electric energy management system. Accordingly, although the electrical outlet to which the electrical device is connected is changed, the change is automatically recognized and thus, a correspondence relationship between the electrical outlet and the electrical device is reconfigured, and the electric energy management system is informed of the reconfigured correspondence relationship so that it is possible to continuously monitor and manage a history of the amount of electric energy consumed by the electrical device.

The transmission time of the RF signal is minimized by measuring an infinitesimal amount of electric energy used when the electrical device is connected to the electrical outlet or by sensing a connection between the electrical device and the electrical outlet. Therefore, it is possible to minimize the amount of electric energy consumed when electric energy is managed.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an electrical outlet for automatically sensing an electrical device according to an embodiment of the present invention;

FIG. 2 is a block diagram illustrating an electric energy management system according to an embodiment of the present invention;

FIG. 3 is a block diagram illustrating an electrical outlet for automatically sensing an electrical device according to another embodiment of the present invention;

FIG. 4 is a diagram illustrating the plug sensor of an electrical outlet according to an embodiment of the present invention; and

FIG. 5 is a flowchart illustrating a method of managing electric energy according to the embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, the embodiments of the present invention will be described in detail with reference to the accompanying drawings.

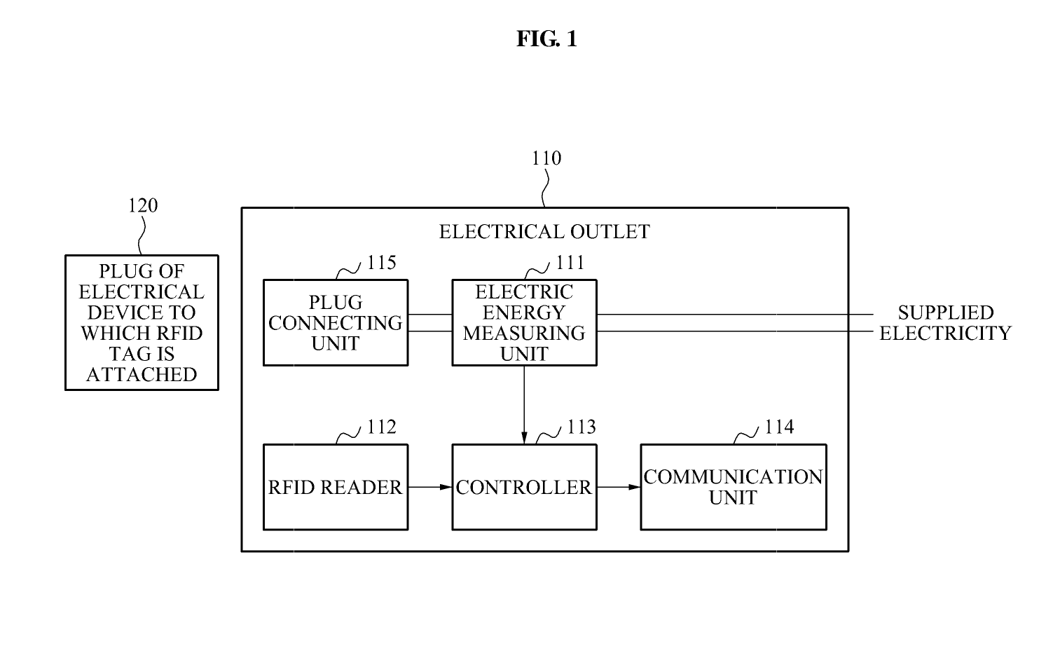

FIG. 1 is a block diagram illustrating an electrical outlet for automatically sensing an electrical device according to an embodiment of the present invention

Referring to FIG. 1, an electrical outlet 110 includes an electric energy measuring unit 111, a radio frequency identification (RFID) reader 112, a controller 113, and a communication unit 114. A plug 120 of an electrical device to which an RFID tag is attached is connected to the electrical outlet 110 through a plug connecting unit 115 provided in the electrical outlet 110.

The electric energy measuring unit 111 is connected to an electricity source supplied to the plug 120 of the electrical device to which the RFID tag is attached through the plug connecting unit 115 to measure an amount of electric energy consumed by the corresponding electrical device.

The RFID tag that stores information about the electrical device may be included in the electrical device and may be used as the identifier of the corresponding electrical device. For example, the RFID tag may be attached to the plug of the electrical device in consideration of a distance at which the RFID reader 112 may recognize the RFID tag.

When the RFID tag is provided in the electrical device, the RFID reader 112 senses the RFID tag to receive information about the corresponding electrical device and to utilize information about the electrical device connected to the electrical outlet 110. The RFID reader 112 periodically transmits a radio frequency (RF) signal to continuously monitor the presence of the RFID tag that is in close proximity to the electrical outlet 110.

The controller 113 receives information about an amount of electric energy measured by the electric energy measuring unit 111, and stores and manages information about the electrical device received from the RFID reader 112. Although not shown, the electrical outlet 110 may include a storage unit for storing information about the amount of electric energy used by the electrical device and information, such as the identifier, related to the corresponding electrical device.

The communication unit 114 receives the information about the amount of electric energy consumed by the corresponding electrical device and the information about the corresponding electrical device from the controller 113 to transmit the received information to another external apparatus, for example, an electric energy management system and an electrical outlet that communicates with the electric energy management system.

The RFID reader 112 of the electrical outlet 110 according to the present invention transmits the RF signal to continuously monitor the presence of the RFID tag that is in close proximity to the electrical outlet 110. However, the RFID reader 112 uses electric energy when the RF signal is transmitted. Accordingly, the RFID reader 112 reads the RFID tag only once, at the moment the electrical device is connected, to obtain necessary information. When the RF signal is always transmitted before and after the electrical device is connected, electric energy is continuously used.

Therefore, the controller 113 of the electrical outlet 110 according to the embodiment of the present invention ceases the RF transmitting function of the RFID reader 112 when the RFID reader 112 recognizes the RFID tag to obtain information after the plug of the electrical device is connected so that an amount of wasted electric energy is reduced in order to use a smaller amount of electric energy when the information about the electrical device is received.

In addition, the controller 113 of the electrical outlet 110 according to an embodiment of the present invention measures an amount of electric energy consumed by a certain electrical device using the electric energy measuring function of the electric energy measuring unit 111 in a case in which the electrical device uses an infinitesimal amount of electric energy corresponding to an amount of standby electric energy when the electrical device is connected to the electrical outlet 110 to determine that the corresponding electrical device is connected and has the RFID reader 112 transmit the RF signal to read the RFID tag of the connected electrical device. Accordingly, it is possible to reduce the amount of wasted electric energy in accordance with the transmission of an unnecessary RF signal before the electrical device is connected to the electrical outlet 110.

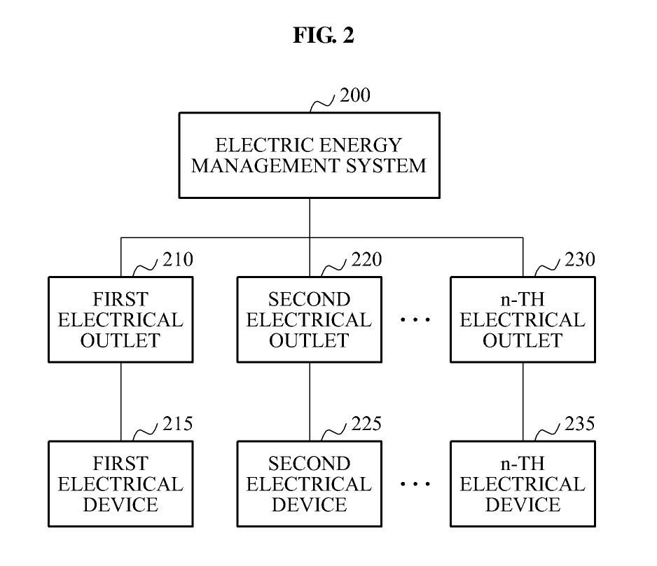

FIG. 2 is a block diagram illustrating an electric energy management system according to the embodiment of the present invention.

A plurality of electrical outlets 210 to 230 according to the present invention transmits information about a plurality of electrical devices 215 to 235 connected to the electrical outlets 210 to 230 and an amount of electric energy consumed by the plurality electrical devices 215 to 235 to an electric energy management system 200 to manage an electric energy usage of the electrical devices in a building.

The electric energy management system 200 for managing the amount of electric energy consumed by the plurality of electrical devices 215 to 235 receives information about the corresponding electrical devices from the RFID tags included in the plurality of electrical devices 215 to 235 and receives the information about the electrical devices and the information about electric energy from the plurality of electrical outlets 210 to 230 for measuring the electric energy used by the electrical devices to manage the amount of electric energy used by the plurality of electrical devices 215 to 235. The electric energy management system 200 may be configured as a home energy management system when the electric energy management system 200 is used in a residential building. In this case, the electric energy management system 200 receives the information about the plurality of electrical devices 215 to 235 connected to the plurality of electrical outlets 210 to 230 and the amount of electric energy consumed by the plurality of electrical devices 215 to 235 from the plurality of electrical outlets 210 to 230 that exist in the residential building to efficiently manage the amount of consumed electric energy. In addition, when one electrical device moves from an electrical outlet to another electrical outlet, the history of electric energy usage of the electrical device may be continuously traced and managed through the information provided by the RFID tags, without a need for input from a user.

In this case, the information provided by the RFID tags included in the electrical devices may be received by the corresponding electrical outlets through the RF signals transmitted by the RFID readers included in the electrical outlets as described above. In addition, the RF signals may be transmitted when the amount of electric energy consumed by the electrical devices is measured by the electrical outlets and may cease transmission when the information about the electrical devices is received by the electrical outlets through the RF signals.

Conversely, in another embodiment, the RF signals may be transmitted when the electrical outlets sense that the plugs of the electrical devices are connected thereto and may cease transmission when the corresponding electrical outlets receive the information about the electrical devices. In this case, the electrical outlet according to the present invention may have the following structure.

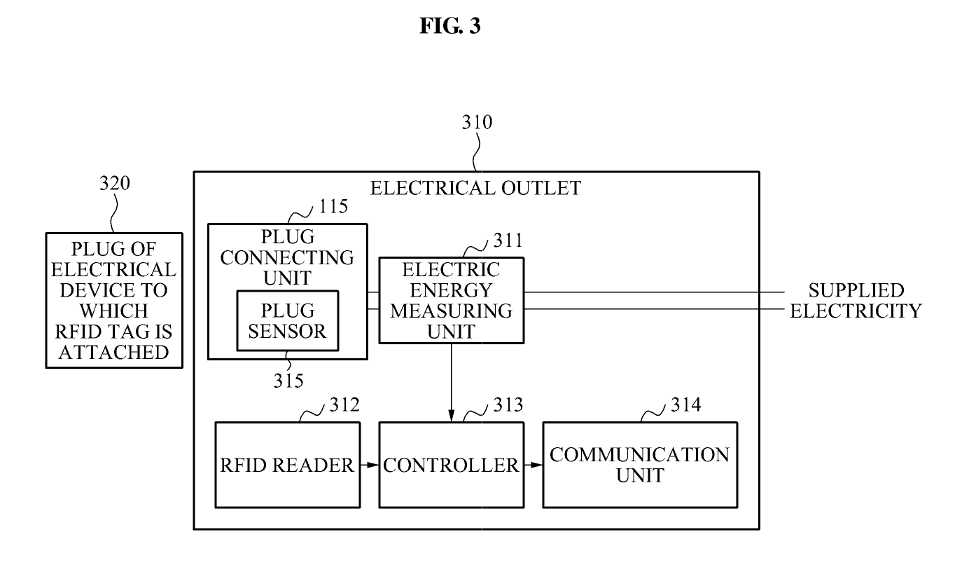

FIG. 3 is a block diagram illustrating an electrical outlet for automatically sensing an electrical device according to another embodiment of the present invention.

Referring to FIG. 3, an electrical outlet 310 according to another embodiment of the present invention includes an electric energy measuring unit 311, an RFID reader 312, a controller 313, and a communication unit 314 similar to the electrical outlet described in FIG. 1 and may further include a plug sensor 315.

The plug sensor 315 is provided in a plug connecting unit 115 where a plug 320 of an electrical device to which an RFID tag is attached is mounted in the electrical outlet of FIG. 1 to mechanically sense whether the plug is mounted.

In this case, the controller 313 provides a signal to the RFID reader 312 to transmit an RF signal when the plug sensor 315 senses that the plug of the electrical device is connected so that information about the electrical device connected to the plug connecting unit 115 is read instead of monitoring an amount of electric energy measured by the electric energy measuring unit 311.

In this instance, the electrical outlet 310 ceases transmission of the RF signal of the RFID reader 312 at normal times, transmits the RF signal only when the connection of the plug is sensed so that the RFID tag may be read, and ceases transmission of the RF signal when the information about the electrical device is received from the RFID tag. Therefore, it is possible to reduce an amount of electric energy wasted resulting from continuous transmission of the RF signal.

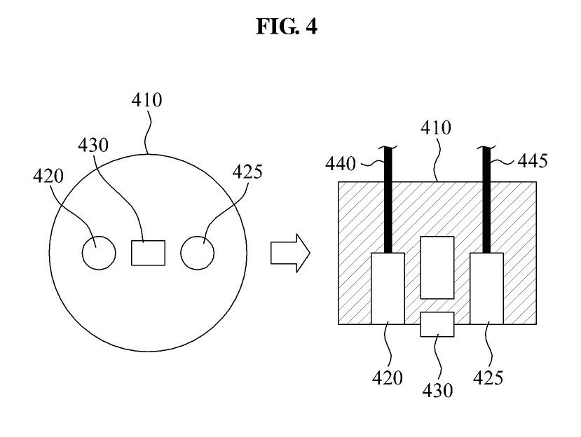

FIG. 4 is a diagram illustrating the plug sensor of an electrical outlet according to the embodiment of the present invention.

A plug sensor 430 is provided on one side of a connection plane between the electrical outlet and the plug of the electrical device to sense whether the plug is connected. For example, the plug sensor 430 is provided in a form having a protruding portion at a center between a positive electric source hole 420 and a negative electric source hole 425 of a plug connecting unit 410 as illustrated in FIG. 4 to be pressed when the plug of the electrical device is mounted and to transmit the connection signal of the electrical device to the controller of the electrical outlet. The positive electric source hole 420 and the negative electric source hole 425 are connected to a positive connection terminal 440 and a negative connection terminal 445.

The plug sensor 430 is provided in a form of a tact switch so that the protruding part is pressed by the central part of the plug when the plug of the electrical device is connected to an electricity source terminal to change an electrical signal.

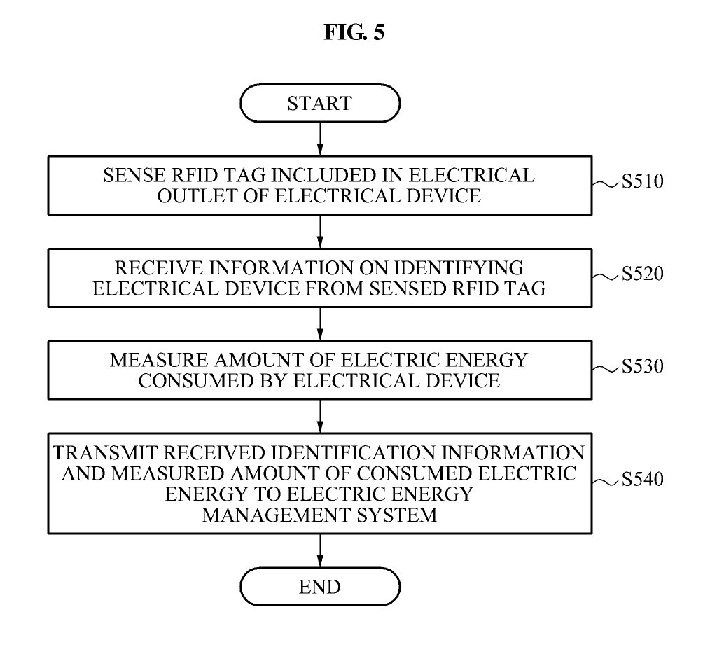

FIG. 5 is a flowchart illustrating a method of managing electric energy according to the embodiment of the present invention.

When the plug of the electrical device including the RFID tag is connected to the electrical outlet, the electrical outlet senses the RFID tag in S510, transmits the RF signal to receive the information about the electrical device in S520, and measures an amount of electric energy consumed by the electrical device in S530.

Then, the received information about the electrical device and information about the measured amount of electric energy are transmitted to the electric energy management system in S540 so that a plurality of electrical devices connected to a plurality of electrical outlets may be managed and monitored.

Here, the electrical outlet may transmit the RF signal for receiving the information about the electrical device from the RFID tag when the amount of electric energy consumed by the electrical device is measured and may cease transmission of the RF signal when the information about the electrical device is received through the RF signal.

Conversely, the electrical outlet may transmit the RF signal when the connection of the plug of the electrical device is sensed and may cease transmission of the RF signal when the information about the electrical device is received.

The electrical outlet may include a storage unit for storing the received information about the electrical device and the information about the measured amount of consumed energy.

The electrical outlets for automatically sensing the electrical devices according to the present invention, the system for managing electric energy using the electrical outlets, and the method thereof may be used when various electrical devices are connected to electrical outlets to be used in a residential building, and the electric energy consumed by the electrical devices is to be conveniently and automatically managed.

A number of electrical devices used in a residential building are rarely moved to other electrical outlets once connected to electrical outlets. However, other electrical devices are moved to other electrical outlets frequently. As an example, refrigerators, washing machines, televisions, and desktop computers correspond to the electrical devices rarely moved to other electrical outlets once connected electrical outlets. Further to this example, hair driers, vacuum cleaners, electric fans, and laptop computers may be connected to various electrical outlets to be used in accordance with the selection of a user. Therefore, when electrical devices are frequently moved, it is difficult to manually input information about an amount of electric energy used by the electrical devices to a home energy management system to manage the amount of the consumed electric energy.

Therefore, using electrical outlets for automatically sensing the electrical devices according to the present invention, the system for managing electric energy using the same, and the method thereof, when an electrical device is connected to a specific electrical outlet, since detailed information about the corresponding electrical device is immediately sensed so that the home energy management system may be informed of the detailed information, the information about the amount of electric energy consumed by all of the electrical devices in a residential building may be continuously and automatically managed.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An electrical outlet, comprising:
a plug connecting unit to which a plug of an electrical device including a radio frequency identification (RFID) tag is connected;
an RFID reader for transmitting a radio frequency (RF) signal to receive information about the electrical device from the RFID tag;
an electric energy measuring unit for measuring an amount of electric energy consumed by the electrical device;
a controller for managing the received information about the electrical device and information about the measured amount of electric energy; and
a communication unit for transmitting the information about the electrical device and the information about the amount of electric energy consumed to an electric energy management system.

2. The electrical outlet of claim 1, wherein the RFID reader ceases transmission of the RF signal when the information about the electrical device is received from the RFID tag.

3. The electrical outlet of claim 1, wherein the RFID reader transmits the RF signal when the amount of electric energy consumed by the electrical device is measured and ceases transmission of the RF signal when the information about the electrical device is received through the RF signal.

4. The electrical outlet of claim 1, wherein the plug connecting unit comprises a plug sensor for sensing whether the plug is connected.

5. The electrical outlet of claim 4, wherein the RFID reader transmits the RF signal, when the connection of the plug is sensed, to receive the information about the electrical device from the RFID tag and ceases transmission of the RF signal when the information about the electrical device is received.

6. The electrical outlet of claim 4, wherein the plug sensor is provided on one side of a connection plane between the electrical outlet and the plug of the electrical device to sense whether the plug is connected.

7. A system for managing an amount of electric energy used by a plurality of electrical devices, wherein information is received from RFID tags corresponding to the plurality of electrical devices and the information about the plurality of electrical devices and information about the amount of electric energy are received from a plurality of electrical outlets for measuring the amount of electric energy used by the plurality of electrical devices so that the amount of electric energy used by the electrical devices is managed.

8. The system of claim 7, wherein the information about the plurality of electrical devices is received from the RFID tags by the electrical outlets in response to RF signals transmitted by RFID readers included in the plurality of electrical outlets.

9. The system of claim 8, wherein transmission of the RF signals ceases when the information about the plurality of electrical devices is received by the plurality of electrical outlets.

10. The system of claim 8, wherein the RF signals are transmitted when the amount of electric energy used by the plurality of electrical devices is measured by the plurality of electrical outlets and transmission ceases when the information about the electrical devices is received from the RFID tags by the electrical outlets in response to the RF signals.

11. The system of claim 10, wherein the RF signals are transmitted when the plurality of electrical outlets senses that the plugs of the plurality of electrical devices are connected and a transmission ceases when the plurality of electrical outlets receives the information about the plurality of electrical devices.

12. A method of managing an amount of electric energy consumed by a plurality of electrical devices, the method comprising:
transmitting information about the electrical devices from RFID tags to electrical outlets and measuring the amount of electric energy consumed by the electrical devices when the plugs of the electrical devices including the RFID tags are connected to the electrical outlets; and
transmitting the transmitted information about the electrical devices and information about the measured amount of electric energy from the electrical outlets to an electric energy management system.

13. The method of claim 12, wherein RF signals for receiving the information about the electrical devices are transmitted from the RFID tags when the amount of electric energy consumed by the electrical devices is measured and ceases when the information about the electrical devices is received from the RFID tags in response to the RF signals.

14. The method of claim 12, wherein the RF signals for receiving the information about the electrical devices are transmitted from the RFID tags when a connection of the plugs to the electrical devices is sensed and ceases when the information about the electrical devices is received.

15. The method of claim 12, further comprising storing the received information about the electrical devices and the information about the measured amount of electric energy in the electrical outlets.
